(19) United States
(12) Patent Application Publication
(10) Pub. No.: US 2024/0375520 A1
(43) Pub. Date: Nov. 14, 2024

(54) BRAKING CONTROL DEVICE FOR VEHICLE

(71) Applicant: ADVICS CO., LTD., Kariya-shi, Aichi-ken (JP)

(72) Inventor: Shunya WATANABE, Kariya-shi, Aichi-ken (JP)

(73) Assignee: ADVICS CO., LTD., Kariya-shi, Aichi-ken (JP)

(21) Appl. No.: 18/684,341

(22) PCT Filed: Aug. 31, 2022
(86) PCT No.: PCT/JP2022/032707

§ 371 Date: Feb. 16, 2024

(30) Foreign Application Priority Data
Aug. 31, 2021 (JP) 2021-141037

(51) Int. Cl. B60L 7/26

(52) U.S. Cl. CPC B60L 7/26

(57) ABSTRACT

In a vehicle to which a braking control device is applied, the ratio of the rear wheel frictional braking force to the front wheel frictional braking force becomes a prescribed value in a state where the front and rear wheel pressures are equal. An actuator generates front wheel frictional braking force by adjusting front wheel pressure and generates rear wheel frictional braking force by adjusting rear wheel pressure, and a controller that controls the actuator. When the regeneration device can generate the regenerative braking force, the controller individually adjusts the front and rear wheel pressures based on a regenerative braking force so that the ratio of the total rear wheel braking force to the total front wheel braking force becomes a prescribed value. However, when the regeneration device cannot generate the regenerative braking force, the controller adjusts the front wheel pressure and the rear wheel pressure to be equal.

### TECHNICAL FIELD

The present disclosure relates to a braking control device for a vehicle.

### BACKGROUND ART

The applicant has developed a braking control device capable of simultaneously applying different fluid pressures to the front wheel and the rear wheel by a single pressurization configuration using an electric motor as described in Patent Literature 1 in order to achieve both improvement in fuel efficiency and improvement in vehicle stability in regeneration cooperative control. Specifically, the braking control device is a braking control device that adjusts a front wheel brake fluid pressure (also referred to as “front wheel pressure”) of a front wheel cylinder provided in a front wheel of a vehicle and a rear wheel brake fluid pressure (also referred to as “rear wheel pressure”) of a rear wheel cylinder provided in a rear wheel of the vehicle, and includes a fluid pressure generation unit that adjusts a fluid pressure generated by an electric motor to obtain an adjusted fluid pressure and applies the adjusted fluid pressure as a rear wheel brake fluid pressure, and a fluid pressure correction unit that reduces and adjusts the adjusted fluid pressure to obtain a corrected fluid pressure and applies the corrected fluid pressure as a front wheel brake fluid pressure.

The braking control device described in Patent Literature 1 improves vehicle stability in regeneration cooperative control in a case where the regeneration device performs energy regeneration. It is desired that the braking control device can ensure vehicle stability even when the regeneration device cannot regenerate energy (for example, in a case where the regeneration device fails).

### CITATIONS LIST

### Patent Literature

Patent Literature 1: Japanese Patent Application Laid-Open No. 2019 059458

### SUMMARY

### Technical Problems

An object of the present disclosure is to provide a braking control device for a vehicle which executes regeneration cooperative control, in which vehicle stability can be secured even when a regeneration device cannot perform energy regeneration.

### Solutions to Problems

A braking control device for a vehicle according to the present disclosure is applied to a vehicle (JV) which including a regeneration device (KC) on one of a front wheel (WHf) and a rear wheel (WHr), and includes a “an actuator (HU) that generates a front wheel frictional braking force (Fmf) by adjusting a front wheel pressure (Pwf) of a front wheel cylinder (CWf) provided on the front wheel (WHf), and generates a rear wheel frictional braking force (Fmr) by adjusting a rear wheel pressure (Pwr) of a rear wheel cylinder (CWf) provided on the rear wheel (WHr)” and a “controller (ECU) that controls the actuator (HU)”. Here, the vehicle (JV) is configured such that a ratio (Km) of the rear wheel frictional braking force (Fmr) to the front wheel frictional braking force (Fmf) becomes a prescribed value (hb) in a state where the front and rear wheel pressures (Pwf, Pwr) are equal.

In the braking control device for the vehicle according to the present disclosure, the controller (ECU) individually adjusts the front and rear wheel pressures (Pwf, Pwr) based on the regenerative braking force (Fg) such that a ratio of a total braking force (Fbr) of the rear wheel (WHr) to a total braking force (Fbf) of the front wheel (WHf) becomes the prescribed value (hb) in a first state (FK=0) in which the regeneration device (KC) can generate the regenerative braking force (Fg). In the second state (FK=1) in which the regeneration device (KC) cannot generate the regenerative braking force (Fg), the controller (ECU) adjusts the front wheel pressure (Pwf) to be equal to the rear wheel pressure (Pwr).

According to the above configuration, even when the regeneration device KC is in a malfunction state, the ratio of the total rear wheel braking force Fbr to the total front wheel braking force Fbf is maintained at the prescribed value hb. As a result, the vehicle stability can be maintained even when the regeneration device KC malfunctions.

### BRIEF DESCRIPTION OF DRAWINGS

FIG. 1 is a schematic view for explaining an entire vehicle JV equipped with a braking control device SC.

FIG. 2 is a schematic view for explaining a first embodiment of the braking control device SC.

FIG. 3 is a flowchart for explaining a process of regeneration cooperative control.

FIG. 4 is a time-series diagram for explaining the operation of the regeneration cooperative control according to the first embodiment of the braking control device SC.

FIG. 5 is a schematic view for explaining a second embodiment of the braking control device SC.

FIG. 6 is a time-series diagram for explaining the operation of the regeneration cooperative control according to the second embodiment of the braking control device SC.

### DESCRIPTION OF EMBODIMENTS

### <Symbols and the Like of Components>

In the following description, components such as members, signals, and values denoted by the same symbol such as “CW” have the same function. The subscripts “f” and “r” attached to the end of various symbols related to the wheel are comprehensive symbols indicating which of the front wheel and the rear wheel the elements relate to. Specifically, “f” indicates “an element related to the front wheel”, and “r” indicates “an element related to the rear wheel”. For example, in the wheel cylinder CW, it is described as “front wheel cylinder CWf, rear wheel cylinder CWr”. Furthermore, the subscripts “f” and “r” may be omitted. When these are omitted, each symbol represents a generic name thereof.

<Vehicle JV Equipped with Braking Control Device SC>

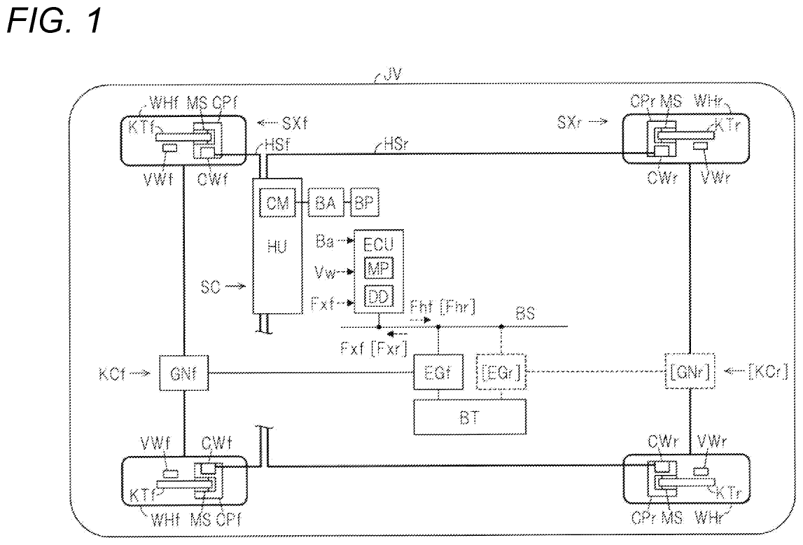

An overall configuration of a vehicle JV equipped with a braking control device SC according to the present disclosure will be described with reference to a schematic view of FIG. 1.

The vehicle JV is a hybrid vehicle or an electric vehicle including a driving electric motor. The driving electric motor also functions as a generator for energy regeneration. A generator GNf is provided on a front wheel WHf. The generator GNf (also referred to as a “front wheel generator”) is controlled (driven) by a controller EGf for the generator. Here, a device including the generator GNf and the controller EGf is referred to as a “regeneration device KCf (alternatively, the front wheel regeneration device KCf)”. The vehicle JV includes a storage battery BT for the regeneration device KCf. That is, the regeneration device KCf also includes the storage battery BT.

When the electric motor/generator GNf operates as a driving electric motor (at the time of acceleration of the vehicle JV), the power is supplied from the storage battery BT to the electric motor/generator GNf via the controller EGf (referred to as a “regenerative controller” or a “front wheel regenerative controller”) for the regeneration device. On the other hand, when the electric motor/generator GNf operates as a generator (at the time of deceleration of the vehicle JV), the power generated by the generator GNf is stored in the storage battery BT via the regenerative controller EGf (so-called regenerative braking is performed). In the regenerative braking, a front wheel regenerative braking force Fgf is independently and individually generated with respect to a frictional braking force Fm to be described later by the generator GNf.

The vehicle JV includes front wheel and rear wheel braking devices SXf and SXr (=SX). The braking device SX generates front and rear wheel frictional braking forces Fmf and Fmr on the front wheel WHf and the rear wheel WHr. The braking device SX includes a rotating member (for example, a brake disc) KT and a brake caliper CP. The rotating member KT is fixed to the wheel WH, and the brake caliper CP is provided so as to sandwich the rotating member KT. The brake caliper CP is provided with a wheel cylinder CW. The wheel cylinder CW is supplied with a pressurized brake fluid BF from the braking control device SC. A friction member (for example, a brake pad) MS is pressed against the rotating member KT by a fluid pressure Pw (referred to as “wheel pressure”) in the wheel cylinder CW. Since the rotating member KT and the wheel WH are fixed so as to rotate integrally, a frictional braking force Fm is generated on the wheel WH by the frictional force generated at this time. That is, the frictional braking force Fm is generated by friction between the rotating member KT and the friction member MS.

The vehicle JV includes a braking operation member BP and various sensors (BA and the like). The braking operation member (for example, a brake pedal) BP is a member operated by the driver to decelerate the vehicle. The vehicle JV is provided with a braking operation amount sensor BA so as to detect the operation amount Ba (also referred to as “braking operation amount”) of the braking operation member BP. As the braking operation amount sensor BA, at least one of a simulator pressure sensor PS that detects a fluid pressure Ps (referred to as “simulator pressure”) of a stroke simulator SS (described later), an operation displacement sensor SP that detects an operation displacement Sp of the braking operation member BP, and an operation force sensor FP that detects an operation force Fp of the braking operation member BP is adopted. That is, at least one of the simulator pressure Ps, the braking operation displacement Sp, and the braking operation force Fp is detected as the braking operation amount Ba by the operation amount sensor BA. The braking operation amount Ba is input to a controller ECU (also simply referred to as a “brake controller” or a “controller”) for the braking control device SC. The vehicle JV includes various sensors including a wheel speed sensor VW that detects the rotational speed (wheel speed) Vw of the wheel WH. The detection signals (Ba and the like) of these sensors are input to the brake controller ECU. In the brake controller ECU, a vehicle body speed Vx is calculated based on the wheel speed Vw.

The vehicle JV includes the braking control device SC so as to execute so-called regeneration cooperative control (control to operate the regenerative braking force Fg and the frictional braking force Fm in cooperation). In the braking control device SC, a so-called front-rear type (also referred to as “type II”) is adopted as a two-system braking system. The braking control device SC supplies the wheel pressure Pw to the braking device SX (in particular, the wheel cylinder CW) via the front wheel and rear wheel communication paths HSf and HSr according to the operation amount Ba of the braking operation member BP. The braking control device SC includes a fluid unit HU (also referred to as “actuator”) including a master cylinder CM and a brake controller ECU.

The fluid unit HU is controlled by the brake controller ECU. The brake controller ECU includes a microprocessor MP that performs signal processing, and a drive circuit DD that drives an electromagnetic valve and an electric motor. The brake controller ECU is connected to the controller EGf for the regeneration device via a communication bus BS. Therefore, information (detection value, calculation value) is shared between these controllers. For example, a target regenerative braking force Fhf is calculated by the brake controller ECU and transmitted to the regenerative controller EGf. A limit regenerative braking force Fxf and an operation flag FK are determined by the regenerative controller EGf and transmitted to the brake controller ECU. The braking operation amount Ba, the wheel speed Vw, the limit regenerative braking force Fx, the operation flag FK (control flag representing the operation state of the regeneration device KCf), and the like are input to the brake controller ECU. The fluid unit HU is controlled by the brake controller ECU based on these signals.

### First Embodiment of Braking Control Device SC

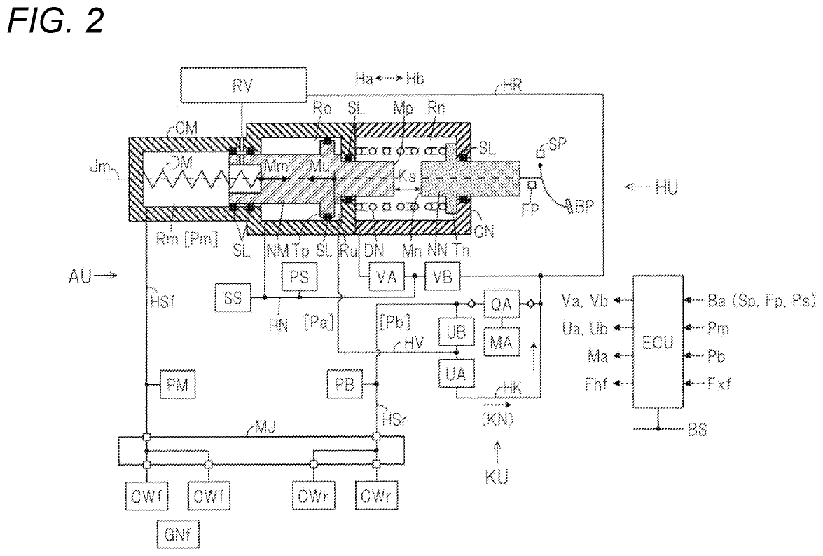

A first embodiment (particularly, a configuration example of the fluid unit HU) of the braking control device SC will be described with reference to the schematic view of FIG. 2. The braking control device SC includes a fluid unit HU as a pressure source for increasing the fluid pressure (wheel pressure) Pw of the four wheel cylinders CW. In the exemplified braking control device SC, the fluid unit HU and the master cylinder CM are integrated. Further, as the braking control device SC, a front-rear type (also referred to as “type II”) braking system is adopted. The fluid unit HU is configured by an apply unit AU including the master cylinder CM and a pressurizing unit KU.

The apply unit AU and the pressurizing unit KU are controlled by the brake controller ECU. Specifically, the braking operation amount Ba (at least one of simulator pressure Ps, operation displacement Sp, and operation force Fp), the master pressure Pm, the second servo pressure Pb, and the front wheel limit regenerative braking force Fxf are input to the controller ECU. Then, drive signals Va and Vb of first and second on-off valves VA and VB, drive signals Ua and Ub of first and second pressure adjusting valves UA and UB, a drive signal Ma of an electric motor MA, and the front wheel target regenerative braking force Fhf are calculated based on these signals. The electromagnetic valve “VA, VB, UA, UB” constituting the fluid unit HU and the electric motor MA are controlled (driven) according to the drive signal “Va, Vb, Ua, Ub, Ma”.

As described later, the fluid unit HU, the wheel cylinder CW, and the like are connected by a reservoir passage HR, a communication path HS(=HSf, HSr), an input passage HN, a servo passage HV, and a reflux passage HK. These are fluid paths through which the brake fluid BF is moved. The fluid path (HS or the like) corresponds to a fluid pipe, a flow path in the fluid unit HU, a hose, or the like.

### <<Apply Unit AU>>

The apply unit AU includes a master reservoir RV, a master cylinder CM, a master piston NM, a master spring DM, an input cylinder CN, an input piston NN, an input spring DN, first and second on-off valves VA and VB, a stroke simulator ss, and a simulator pressure sensor PS.

The master reservoir (also referred to as “atmospheric pressure reservoir”) RV is a tank for a working fluid, and the brake fluid BF is stored therein. The master reservoir RV is connected to the master cylinder CM (in particular, the master chamber Rm).

The master cylinder CM is a cylinder member having a bottom portion. The master piston NM is inserted into the master cylinder CM, and the inside thereof is sealed by a seal member SL to form the master chamber Rm. The master cylinder CM is a so-called single type. A master spring DM is provided in the master chamber Rm so as to press the master piston NM in a retreating direction Hb (a direction in which the volume of the master chamber Rm increases, and a direction opposite to an advancing direction Ha). The master chamber Rm is finally connected to the front wheel cylinder CWf via a front wheel communication path HSf and a fluid pressure modulator MJ. When the master piston NM is moved in the advancing direction Ha (direction in which the volume of the master chamber Rm decreases), the brake fluid BF is pumped from the fluid unit HU (in particular, the master cylinder CM) toward the front wheel cylinder CWf at the fluid pressure Pm. The fluid pressure Pm of the master chamber Rm is called “master pressure”.

The master piston NM is provided with a flange portion (flange) Tp. The flange portion Tp further partitions the inside of the master cylinder CM into a servo chamber Ru and a rear chamber Ro. The servo chamber Ru is disposed so as to face the master chamber Rm across the master piston NM. The rear chamber Ro is sandwiched between the master chamber Rm and the servo chamber Ru, and is disposed therebetween. The servo chamber Ru and the rear chamber Ro are also sealed by the seal member SL in the same manner as described above.

For example, a pressure receiving area ru (that is, it is a pressure receiving area of the servo chamber Ru, and is also referred to as a “servo area”) of the flange portion Tp of the master piston NM and the pressure receiving area rm (that is, it is a pressure receiving area of the master chamber Rm, and is also referred to as “master area”) of the end portion of the master piston NM are set to be equal to each other. In this case, the fluid pressure Pa (first servo pressure) of the servo chamber Ru and the fluid pressure Pm (master pressure) of the master chamber Rm are statically equal if friction or the like is ignored.

The input cylinder CN is fixed to the master cylinder CM. The input piston NN is inserted into the input cylinder CN and sealed by the seal member SL to form an input chamber Rn. The input piston NN is mechanically connected to the braking operation member BP via a clevis (U-shaped link). The input piston NN is provided with a flange portion (flange) Tn. The input spring DN is provided between the flange portion Tn and the attachment surface of the input cylinder CN with respect to the master cylinder CM. The input piston NN is pressed in the retreating direction Hb by the input spring DN.

In a state where the input piston NN and the master piston NM are pressed in the most retreating direction Hb, the input piston NN and the master piston NM have a gap Ks (also referred to as a “separation distance”). The gap Ks forms a state in which the wheel pressure Pw does not change even when a displacement Sp of the braking operation member BP occurs. In other words, since the input piston NN and the master piston NM are separated from each other with the gap Ks, the braking control device SC is brake-by-wire, and regeneration cooperative control can be achieved.

The apply unit AU is provided with an input chamber Rn, a servo chamber Ru, a rear chamber Ro, and a fluid pressure chamber of the master chamber Rm. Here, the “fluid pressure chamber” is a chamber filled with the brake fluid BF and sealed by the seal member SL. The volumes of the respective fluid pressure chambers are changed by the movement of the input piston NN and the master piston NM. In the arrangement of the fluid pressure chamber, the input chamber Rn, the servo chamber Ru, the rear chamber Ro, and the master chamber Rm are arranged in this order from the side closer to the braking operation member BP along a central axis line Jm of the master cylinder CM.

The input chamber Rn and the rear chamber Ro are connected via the input passage HN. The input passage HN is provided with a first on-off valve VA. The input passage HN is connected to the master reservoir RV via the reservoir passage HR between the rear chamber Ro and the first on-off valve VA. The reservoir passage HR is provided with a second on-off valve VB. The first and second on-off valves VA and VB are two-position electromagnetic valves (also referred to as “on-off valves”) having an open position (communication state) and a closed position (cutoff state). A normally closed electromagnetic valve is employed as the first on-off valve VA. A normally open electromagnetic valve is employed as the second on-off valve VB. The first and second on-off valves VA and VB are driven (controlled) by drive signals Va and Vb from the brake controller ECU.

A stroke simulator (also simply referred to as a “simulator”) SS is connected to the rear chamber Ro. The operation force Fp of the braking operation member BP is generated by the simulator SS. A piston and an elastic body (for example, a compression spring) are provided inside the simulator SS. When the brake fluid BF flows into the simulator SS, the piston is pushed by the brake fluid BF. Since a force is applied to the piston in a direction in which the inflow of the brake fluid BF is blocked by the elastic body, the operation force Fp of the braking operation member BP is generated. The operation characteristic (relationship between the operation displacement Sp and the operation force Fp) of the braking operation member BP is formed by the simulator SS.

The simulator pressure sensor PS is provided to detect the fluid pressure (referred to as “simulator pressure”) Ps of the simulator SS. The simulator pressure Ps is a state quantity corresponding to the operation force Fp, and is also the fluid pressure of the input chamber Rn and the rear chamber Ro. The simulator pressure sensor PS is one of the above-described braking operation amount sensors BA, and the simulator pressure Ps is input to the controller ECU for the braking control device SC as the braking operation amount Ba.

In addition to the simulator pressure sensor PS, the fluid unit HU is provided with, as the braking operation amount sensor BA, an operation displacement sensor SP that detects the operation displacement Sp of the braking operation member BP and/or an operation force sensor FP that detects the operation force Fp of the braking operation member BP. That is, at least one of the simulator pressure sensor PS, the operation displacement sensor SP (stroke sensor), and the operation force sensor FP is adopted as the braking operation amount sensor BA. Therefore, the braking operation amount Ba is at least one of the simulator pressure Ps, the operation displacement Sp, and the operation force Fp.

### <<Pressurizing Unit KU>>

A fluid pressure Pwf (front wheel pressure) of the front wheel cylinder CWf and a fluid pressure Pwr (rear wheel pressure) of the rear wheel cylinder CWr are independently and individually adjusted by the pressurizing unit KU. However, in the magnitude relationship between the front wheel pressure Pwf and the rear wheel pressure Pwr, the front wheel pressure Pwf is equal to or less than the rear wheel pressure Pwr. The pressurizing unit KU includes an electric motor MA, a fluid pump QA, first and second pressure adjusting valves UA and UB, and a servo pressure sensor PB.

The fluid pump QA is driven by the electric motor MA, and the wheel pressure Pw is increased by the brake fluid BF discharged from the fluid pump QA. Therefore, the electric motor MA is a power source for increasing the fluid pressure (wheel pressure) Pw of the wheel cylinder CW. The electric motor MA is controlled by the brake controller ECU according to the drive signal Ma.

The suction unit of the fluid pump QA is connected to the master reservoir RV via the reservoir passage HR. In the fluid pump QA, the suction unit and the discharge unit are connected via the reflux passage HK. Therefore, when the electric motor MA is driven, a circulation flow KN of the brake fluid BF is generated in the reflux passage HK by the brake fluid BF discharged from the fluid pump QA (see the broken line arrow in the drawing). Here, in the circulation flow KN, a side close to the discharge unit of the fluid pump QA is referred to as an “upstream side”, and a side far from the discharge unit is referred to as a “downstream side”.

In the reflux passage HK, two pressure adjusting valves UA and UB are provided in series. Specifically, the reflux passage HK is provided with the first pressure adjusting valve UA. The second pressure adjusting valve UB is provided between the first pressure adjusting valve UA and the discharge unit of the fluid pump QA. Therefore, in the circulation flow KN, the second pressure adjusting valve UB is disposed on the upstream side of the first pressure adjusting valve UA. The first and second pressure adjusting valves UA and UB are linear type electromagnetic valves (also referred to as a “proportional valve” or a “differential pressure valve”) in which a valve opening amount (lift amount) is continuously controlled based on an energized state (for example, the supply current). As the first and second pressure adjusting valves UA and UB, normally open electromagnetic valves are employed. The first and second pressure adjusting valves UA and UB are controlled by the brake controller ECU based on the drive signals Ua and Ub.

The fluid pressure Pa between the first pressure adjusting valve UA and the second pressure adjusting valve UB is adjusted only by the first pressure adjusting valve UA. The fluid pressure Pa is called “first servo pressure”. In the braking system related to the front wheel WHf, the reflux passage HK is connected to the servo chamber Ru through the servo passage HV between the first pressure adjusting valve UA and the second pressure adjusting valve UB. Therefore, the first servo pressure Pa is supplied to the servo chamber Ru. The first servo pressure Pa presses the master piston NM to generate the master pressure Pm. The master pressure Pm is supplied to the front wheel cylinder CWf. That is, the front wheel pressure Pwf is finally generated by the first servo pressure Pa. The pressurizing unit KU is provided with a master pressure sensor PM so as to detect the master pressure Pm.

The fluid pressure Pb between the fluid pump QA and the second pressure adjusting valve UB is controlled by both the first and second pressure adjusting valves UA and UB. The fluid pressure Pb is called “second servo pressure”. In the braking system related to the rear wheel WHr, the reflux passage HK is connected to the rear wheel cylinder CWr between the fluid pump QA (in particular, the discharge unit) and the second pressure adjusting valve UB via the rear wheel communication path HSr and the fluid pressure modulator MJ. That is, since the second servo pressure Pb is directly supplied to the rear wheel cylinder CWr, the rear wheel pressure Pwr is generated by the second servo pressure Pb. The pressurizing unit KU is provided with a servo pressure sensor PB (also referred to as a “second servo pressure sensor”) so as to detect the second servo pressure Pb.

When the electric motor MA is driven and the fluid pump QA is operated, the circulation flow KN (flow circulating in “QA→UB→UA→QA”) of the brake fluid BF including the fluid pump QA and the first and second pressure adjusting valves UA and UB is generated. When no power is supplied to the first and second pressure adjusting valves UA and UB and they are in the fully open state, both the first and second servo pressures Pa and Pb are substantially “0 (atmospheric pressure)” (that is, when “Ia=Ib=0”, “Pa=Pb=0”). Here, the pressure loss in the fully opened state of the first and second pressure adjusting valves UA and UB is ignored.

In a state where the second pressure adjusting valve UB is not energized, when power starts to be supplied to the first pressure adjusting valve UA and the energization amount Ia is increased, the circulation flow KN is narrowed by the first pressure adjusting valve UA. As a result, the first servo pressure Pa is increased from “0”. In this state, when power starts to be supplied to the second pressure adjusting valve UB and the energization amount Ib is increased, the circulation flow KN is further narrowed by the second pressure adjusting valve UB. As a result, the second servo pressure Pb is increased from the first servo pressure Pa. That is, the first servo pressure Pa is a differential pressure with respect to “0 (atmospheric pressure)”, and is adjusted only by the first pressure adjusting valve UA. The second servo pressure Pb is a differential pressure with respect to the first servo pressure Pa, and is adjusted by the first and second pressure adjusting valves UA and UB. Therefore, in the magnitude relationship between the first servo pressure Pa and the second servo pressure Pb, the second servo pressure Pb is always equal to or higher than the first servo pressure Pa (that is, “Pb≥Pa”). When power is not supplied to the second pressure adjusting valve UB and the second pressure adjusting valve UB is in the fully open state, the first servo pressure Pa and the second servo pressure Pb are made equal (that is, “Pa=Pb” at “Ib=0”).

A fluid pressure modulator MJ is provided between the braking control device SC and the front and rear wheel cylinders CWf and CWr so that the front and rear wheel pressures Pwf and Pwr can be individually controlled in each wheel cylinder CW. Inside the fluid pressure modulator MJ, the front wheel and rear wheel communication paths HSf and HSr are branched into two and connected to the front and rear wheel cylinders CWf and CWr, respectively. The fluid pressure modulator MJ independently and individually controls each wheel pressure Pw of the anti-lock brake control, the vehicle stability control, and the like. During service braking (service braking), the fluid pressure modulator MJ is not operated.

### <<Operation of Braking Control Device SC>>

At the time of non-braking (for example, when the operation of the braking operation member BP is not performed), the master piston NM is pressed by the master spring DM and returned to their initial position (position moved most in the retreating direction Hb). In this state, the master chamber Rm and the master reservoir RV are in a communication state, and the fluid pressure Pm (master pressure) of the master chamber is “0 (atmospheric pressure)”. At the initial position of the master piston NM, the input piston NN and the master piston NM have a gap Ks. Since the first and second pressure adjusting valves UA and UB are opened at the time of non-braking, the first and second servo pressures Pa and Pb are “0 (atmospheric pressure)”.

At the time of braking (that is, when the braking operation member BP is operated), the first on-off valve VA is opened, and the second on-off valve VB is closed. That is, the input chamber Rn and the rear chamber Ro are communicated with each other, and the communication state between the rear chamber Ro and the master reservoir RV is blocked. As the operation amount Ba of the braking operation member BP increases, the input piston NN is moved in the advancing direction Ha, and the brake fluid BF is discharged from the input chamber Rn. Since the discharged brake fluid BF is absorbed by the stroke simulator SS, a fluid pressure Pn (input pressure) of the input chamber Rn and a fluid pressure Po (rear pressure) of the rear chamber Ro are increased, and the operation force Fp is generated in the braking operation member BP. At this time, the first and second pressure adjusting valves UA and UB are controlled according to the braking operation amount Ba (at least one of simulator pressure Ps, operation displacement Sp, and operation force Fp), and the first and second servo pressures Pa and Pb are increased.

Since the first servo pressure Pa is supplied to the servo chamber Ru, the master piston NM is pressed and moved in the advancing direction Ha. As the master piston NM moves in the advancing direction Ha, the master pressure Pm is increased. Then, the brake fluid BF adjusted to the master pressure Pm is supplied to the front wheel cylinder CWf, and the internal pressure Pwf is increased. In addition, the brake fluid BF adjusted to the second servo pressure Pb is supplied to the rear wheel cylinder CWr, and the internal pressure Pwr is increased. That is, the front wheel pressure Pwf is adjusted to be equal to the first servo pressure Pa, and the rear wheel pressure Pwr is adjusted to be equal to the second servo pressure Pb. At this time, due to the restriction of the fluid unit HU (in particular, the pressurizing unit KU), the front wheel pressure Pwf (=Pa) can be adjusted within a range of the rear wheel pressure Pwr (=Pb) or less.

The braking control device SC is a brake-by-wire type, and performs regeneration cooperative control. Since the input piston NN and the master piston NM have the gap Ks, the relative positional relationship between the input piston NN and the master piston NM can be arbitrarily adjusted within the range of the gap Ks by controlling the first servo pressure Pa. For example, when only the braking force Fgf by the front wheel regeneration device KCf is required, “Pa=0” is set, and the master pressure Pm is kept at “0”. Since the front wheel pressure Pwf is not increased and remains at “0”, the braking force (front wheel frictional braking force) Fmf due to the friction between the rotating member KT and the friction member MS is not generated. Therefore, a total front wheel braking force Fbf is generated only by the front wheel regenerative braking force Fgf.

### <Processing of Regeneration Cooperative Control>

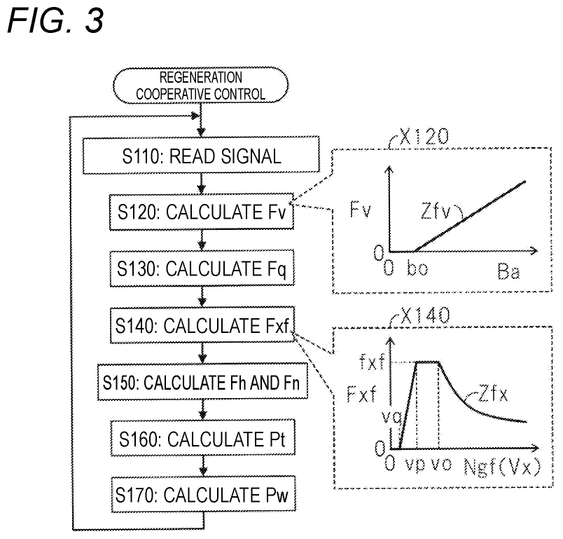

The processing of the regeneration cooperative control will be described with reference to the flowchart of FIG. 3. In the “regeneration cooperative control”, the regenerative braking force Fgf by the generator GNf and the frictional braking force Fmf by the braking control device SC are cooperatively controlled so that kinetic energy of the vehicle JV at the time of braking is efficiently recovered (regenerated) as electric energy. The algorithm of the regeneration cooperative control is programmed in the microprocessor MP of the brake controller ECU.

### <<Total Braking Force Fb, Frictional Braking Force Fm, and Set Distribution Km>>

The actual braking force as a whole of the vehicle JV is called “total vehicle body braking force Fu”. That is, the total vehicle body braking force Fu (actual value) is the total sum of the braking forces acting on the vehicle body of the vehicle JV. In addition, the total sum of the braking forces acting on the front and rear wheels WHf and WHr (also referred to as “total braking force”) is referred to as a “total front and rear wheel braking force Fbf and Fbr”. Therefore, the sum of the total front and rear wheel braking forces Fbf and Fbr is the total vehicle body braking force Fu.

The braking forces actually generated by the front and rear wheel pressures Pwf and Pwr of the front wheels and the rear wheels are called “front and rear wheel frictional braking forces Fmf and Fmr”. In the first embodiment, since the regenerative braking force is not applied to the rear wheel WHr, the total rear wheel braking force Fbr (actual value) coincides with the rear wheel frictional braking force Fmr (actual value). When the regenerative braking force Fgf by the regeneration device KCf is not generated, the total front wheel braking force Fbf (actual value) coincides with the front wheel frictional braking force Fmf (actual value).

In the vehicle JV, a ratio Km (referred to as “set distribution”) of the rear wheel frictional braking force Fmr to the front wheel frictional braking force Fmf is set to a prescribed value hb (also referred to as “reference value”) in a state where the front and rear wheel pressures Pwf and Pwr are equal. Specifically, the set distribution Km is determined to be the prescribed value hb according to the specifications (the pressure receiving area of the wheel cylinder CW, the effective braking radius of rotating member KT, friction coefficient of friction member MS, and the like) of the front wheel and rear wheel braking devices SXf and SXr (=SX) of the vehicle JV. The prescribed value (reference value) hb is a preset constant.

### <<Regeneration Cooperative Control>>

First, regeneration cooperative control when the operation state of the regeneration device KCf is appropriate will be described. Here, a state in which the operation of the regeneration device KCf is appropriate is referred to as a “first state”, and a state in which the operation of the regeneration device KCf is inappropriate is referred to as a “second state”. In the first state, the regeneration device KCf can regenerate the kinetic energy of the vehicle JV and generate the regenerative braking force Fgf. On the other hand, in the second state, the regeneration device KCf cannot regenerate the kinetic energy of the vehicle JV and cannot generate the regenerative braking force Fgf.

The first and second states are transmitted from the regenerative controller EGf to the brake controller ECU through the communication bus BS via the operation flag FK. Here, the operation flag FK is a control flag indicating propriety of the operation state of the regeneration device KCf. Specifically, in the operation flag FK, “0” indicates an appropriate operation (first state), and “1” indicates an inappropriate operation (second state).

In step S110, signals such as the braking operation amount Ba, the master pressure Pm, the second servo pressure Pb, the vehicle body speed Vx, and the operation flag FK are read. The operation amount Ba is calculated based on the detection value of the operation amount sensor BA (simulator pressure sensor PS, operation displacement sensor SP, operation force sensor FP, and the like). The master pressure Pm is calculated based on the detection value of the master pressure sensor PM. The second servo pressure Pb is calculated based on the detection value of the servo pressure sensor PB. The vehicle body speed Vx is calculated based on the wheel speed Vw (detection value of the wheel speed sensor VW). Further, “FK=0 (first state)” is received from the regenerative controller EGf.

In step S120, a target vehicle body power Fv is calculated based on the braking operation amount Ba. The “target vehicle body power Fv” is a target value corresponding to the total braking force Fu (total vehicle body braking force) acting on the vehicle body. The target vehicle body power Fv is calculated to “0” when the braking operation amount Ba is less than the prescribed amount bo based on the braking operation amount Ba and a calculation map Zfv. When the braking operation amount Ba is greater than or equal to the prescribed amount bo, the target vehicle body power Fv is calculated to increase from “0” as the braking operation amount Ba increases from “0”. Here, the prescribed amount bo is a preset prescribed value (constant) representing play of the braking operation member BP.

In step S130, the front and rear wheel required braking forces Fqf and Fqr (=Fq) are calculated based on the target vehicle body power Fv. The “Front and rear wheel required braking forces Fqf and Fqr” is a target value corresponding to the total sum Fbf, Fbr (front wheel and total rear wheel braking force) of the braking forces actually acting on the front wheel WHf and the rear wheel WHr. Therefore, the front wheel required braking force Fqf is a target value corresponding to the sum of the regenerative braking force Fgf (actual braking force by the regeneration device KCf) and the front wheel frictional braking force Fmf (actual braking force by the front wheel pressure Pwf). The rear wheel required braking force Fqr is a target value corresponding to the rear wheel frictional braking force Fmr (actual braking force by the rear wheel pressure Pwr). In the braking control device SC, since the braking forces of the left and right wheels are calculated as the same value, the front wheel required braking force Fqf corresponds to the two wheels in front of the vehicle (that is, the front two wheels WHf), and the rear wheel required braking force Fqr corresponds to the two wheels behind the vehicle (that is, the rear two wheels WHr).

In step S130, the front and rear wheel required braking forces Fqf and Fqr are calculated so that the following two conditions are satisfied.
Condition 1: The sum of the front wheel required braking force Fqf and the rear wheel required braking force Fqr matches the target vehicle body power Fv (that is, “Fv=Fqf+Fqr”).
Condition 2: A ratio Kq (referred to as “required distribution”) of the rear wheel required braking force Fqr to the front wheel required braking force Fqf coincides with the prescribed value hb (=Km) (that is, “Kq=Fqr/Fqf=hb=Km, where the prescribed value hb is a preset constant”).

Specifically, in step S130, the front and rear wheel required braking forces Fqf and Fr are calculated as the following equation (1) with the required distribution Kq as the prescribed value hb (that is, the set distribution Km).

Fqf=Fv/(1+hb), and Fqr=Fv·hb/(1+hb) Expression (1)

In step S140, the limit regenerative braking force Fxf is acquired. The “limit regenerative braking force Fxf” is a maximum value (limit value) of the regenerative braking force Fgf that can be generated by the regeneration device KCf, and is also referred to as “front wheel limit regenerative braking force”. In other words, the limit regenerative braking force Fxf is a state quantity representing the limit of the regenerative braking force Fgf of the front wheel WHf.

The limit regenerative braking force Fxf is restricted by the operation state of the front wheel regeneration device KCf. Therefore, the limit regenerative braking force Fxf is determined based on the operation state of the regeneration device KCf. Specifically, the operation state of the regeneration device KCf corresponds to at least one of a rotational speed Ngf of the front wheel generator GNf, the state (temperature or the like) of the front wheel regenerative controller EGf (in particular, a power transistor such as an IGBT), and the state (charge acceptance amount, temperature, etc.) of the storage battery BT. The limit regenerative braking force Fxf is determined (calculated) by the regenerative controller EGf and acquired by the brake controller ECU via the communication bus BS. For example, in the front wheel regenerative controller EGf, the front wheel limit regenerative braking force Fxf is determined by the following method.

The limit regenerative braking force Fxf (upper limit value of the regenerative braking force Fgf) is determined based on the characteristic Zfx (calculation map) of a block X140. This is because the regeneration amount (as a result, the regenerative braking force Fgf) by the regeneration device KCf is determined by the rating of the power transistor (IGBT or the like) of the regenerative controller EGf and the charge acceptance amount of the storage battery BT (the remaining amount obtained by subtracting the current charge amount from the full charge). Specifically, in the calculation map Zfx, when the rotational speed Ngf of the front wheel generator GNf is greater than or equal to a first prescribed speed vo, the limit regenerative braking force Fxf is determined such that the regenerative power (power) by the regeneration device KCf becomes constant (that is, the product of the limit regenerative braking force Fxf and the rotational speed Ngf becomes constant). Therefore, in “Ngf≥vo”, the limit regenerative braking force Fxf is calculated to increase in an inversely proportional relationship with respect to the rotational speed Ngf as the rotational speed Ngf decreases. In addition, since the regeneration amount decreases when the rotational speed Ngf decreases, in the calculation map Zfx, when the rotational speed Ngf is less than a second prescribed speed vp, the limit regenerative braking force Fxf is calculated to decrease with the decrease of the rotational speed Ngf. Furthermore, since energy regeneration cannot be performed when the rotational speed Ngf is extremely low, in the calculation map Zfx, when the rotational speed Ngf is less than a third prescribed speed vq, the limit regenerative braking force Fxf is calculated to “0”. In addition, a preset upper limit value fxf is provided in the calculation map Zfx so that an excessive deceleration slip (in extreme cases, wheel lock) does not occur in the front wheel WHf by the regenerative braking force Fgf (that is, “Fxf=fxf” is satisfied when “vp≤Ngf<vo”). The first, second, and third prescribed speeds vo, vp, and vq and the upper limit value fxf are prescribed values (constants) set in advance.

In step S150, the target regenerative braking force Fhf and the front and rear wheel target frictional braking forces Fnf and Fnr are calculated based on the front and rear wheel required braking forces Fqf and Fqr and the limit regenerative braking force Fxf. The “target regenerative braking force Fhf” is a target value corresponding to the actual regenerative braking force Fgf to be realized by the regeneration device KCf provided on the front wheel WHf. In addition, the “Front and rear wheel target frictional braking forces Fnf and Fnr (=Fn)” is a target value corresponding to the actual front and rear wheel frictional braking forces Fmf and Fmr (=Fm) to be realized by the braking control device SC.

In step S150, “Whether the front wheel required braking force Fqf is larger than the limit regenerative braking force Fxf (referred to as “limit determination”)” is determined. When the front wheel required braking force Fqf is equal to or less than the limit regenerative braking force Fxf (that is, in a case where the limit determination is denied), the target regenerative braking force Fhf is calculated equal to the front wheel required braking force Fqf, and the front wheel target frictional braking force Fnf is calculated to “0”. The rear wheel target frictional braking force Fnr is calculated equal to the rear wheel required braking force Fqr. That is, in step S150, when “Fqf≤Fxf”, “Fhf=Fqf, Fnf=0, Fnr=Fqr” is determined.

On the other hand, when the front wheel required braking force Fqf is larger than the limit regenerative braking force Fxf (that is, in a case where the limit determination is affirmed), the target regenerative braking force Fhf is calculated equal to the limit regenerative braking force Fxf, and the front wheel target frictional braking force Fnf is calculated to a value obtained by subtracting the limit regenerative braking force Fxf from the front wheel required braking force Fqf. The rear wheel target frictional braking force Fnr is calculated equal to the rear wheel required braking force Fqr. That is, in step S150, if “Fqf>Fxf”, “Fhf=Fxf, Fnf=Fqf−Fxf, Fnr=Fqr” is determined.

The target regenerative braking force Fhf calculated in step S150 is transmitted from the brake controller ECU to the regenerative controller EGf through the communication bus BS. Then, the front wheel generator GNf is controlled by the front wheel regenerative controller EGf so that the actual front wheel regenerative braking force Fgf approaches and matches the target regenerative braking force Fhf.

In step S160, the front and rear wheel target pressures Ptf and Ptr (=Pt) are calculated based on the front and rear wheel target frictional braking forces Fnf and Fnr (=Fn). The front and rear wheel target pressures Ptf and Ptr are target values corresponding to the front and rear wheel pressures Pwf and Pwr (=Pw). The target pressure Pt (=Ptf, Ptr) is determined by simply converting the target frictional braking force Fn (=Fnf, Fnr) into the dimension of the wheel pressure Pw (=Pwf, Pwr) based on the specifications (the pressure receiving area of the wheel cylinder CW, the effective braking radius of the rotating member KT, the friction coefficient of the friction member MS, the effective radius of the wheel (tire), and the like) of the braking device SX and the like. Since the front wheel pressure Pwf is equal to the master pressure Pm, the front wheel target pressure Ptf is also a target value of the master pressure Pm. Since the rear wheel pressure Pwr is equal to the second servo pressure Pb, the rear wheel target pressure Ptr is also a target value of the second servo pressure Pb.

In step S170, the front and rear wheel pressures Pwf and Pwr (actual values) are adjusted based on the front and rear wheel target pressures Ptf and Ptr (target values). The electric motor MA and the first and second pressure adjusting valves UA and UB are driven by the brake controller ECU, and the front and rear wheel pressures Pwf and Pwr are controlled to approach and match the front and rear wheel target pressures Ptf and Ptr. Specifically, first, the electric motor MA is driven to generate the circulation flow KN including the fluid pump QA and the first and second pressure adjusting valves UA and UB. Then, based on the front wheel target pressure Ptf and the master pressure Pm (the detection value of the master pressure sensor PM), the first pressure adjusting valve UA is subjected to fluid pressure feedback control such that the master pressure Pm (=Pwf) matches the front wheel target pressure Ptf. That is, the supply current Ia (also referred to as “first current”) to the first pressure adjusting valve UA is adjusted such that a deviation hPf between the master pressure Pm and the front wheel target pressure Ptf becomes “0”. Furthermore, based on the rear wheel target pressure Ptr and the second servo pressure Pb (detection value of the servo pressure sensor PB), the second pressure adjusting valve UB is subjected to fluid pressure feedback control so that the second servo pressure Pb (=Pwr) matches the rear wheel target pressure Ptr. That is, the supply current Ib (also referred to as “second current”) to the second pressure adjusting valve UB is adjusted such that a deviation hPr between the second servo pressure Pb and the rear wheel target pressure Ptr becomes “0”.

<<Control when Regeneration Device KCf is Malfunctioning>>

Next, a case where the operation state of the regeneration device KCf provided on the front wheel WHf is not appropriate (for example, in a case where the regeneration device KCf fails) will be described. When the operation of the regeneration device KCf is malfunctioning (that is, in the case of the second state), the regenerative braking force Fgf cannot be generated by the generator GNf. The second state is transmitted from the regenerative controller EGf via the communication bus BS by “FK=1”.

For example, the second state is determined based on a state such as the temperature of the regenerative controller EGf. When a temperature Tg of the regenerative controller EGf is higher than a prescribed temperature tg, the second state is determined. In addition, also in a case where a temperature Tb of the storage battery BT is higher than a prescribed temperature tb, the second state is determined in the same manner. Note that the prescribed temperatures tg and tb are thresholds for determination and are prescribed values (constants) set in advance.

“Fhf=0, Fnf=Fqf, Fnr=Fqr” is calculated in step S150 from the calculation cycle in which “FK=1 (second state)” is received. Accordingly, in step S160, the front wheel target pressure Ptf is determined to match the rear wheel target pressure Ptr. That is, the front wheel target pressure Ptf is increased, and the front wheel target pressure Ptf and the rear wheel target pressure Ptr are equalized. In the increase of the front wheel target pressure Ptf, a temporal change amount dPf is limited by a prescribed gradient kf. The prescribed gradient kf is a prescribed value (constant) set in advance.

In step S170, the wheel pressure Pw (actual value) is adjusted based on the target pressure Pt (target value). Specifically, the supply current Ia (first current) to the first pressure adjusting valve UA is increased in accordance with the increase in the front wheel target pressure Ptf. At this time, an increase gradient (temporal change amount) dPf of the front wheel target pressure Ptf is limited to the prescribed gradient kf, so that the first current Ia is gradually increased. As a result, the front wheel pressure Pwf is gradually increased.

Furthermore, in step S170, the supply current Ib (second current) to the second pressure adjusting valve UB is decreased according to the increase in the first current Ia. The difference sPt (=“Ptr−Ptf” and referred to as “target pressure difference”) between the front wheel target pressure Ptf and the rear wheel target pressure Ptr is decreased toward “0”, and the second current Ib is adjusted based on the target pressure difference sPt. Specifically, as the target pressure difference sPt gradually decreases, the second current Ib gradually decreases. Finally, the second current is set to “0”, and the second pressure adjusting valve UB is fully opened. As a result, the first servo pressure Pa (=Pwf) and the second servo pressure Pb (=Pwr) are forcibly made the same.

In the braking control device SC, in the first state (that is, in a case where energy regeneration by the regeneration device KCf is possible), the front wheel target pressure Ptf and the rear wheel target pressure Ptr are individually calculated based on the front wheel regenerative braking force Fgf so that the required distribution Kq (that is, “Fqr/Fqf”) matches the prescribed value hb (that is, the set distribution Km). That is, since the regenerative braking force Fgf can be generated on the front wheel WHf in the first state, the front wheel target pressure Ptf is determined to be lower than the rear wheel target pressure Ptr (that is, the state of “Pwf<Pwr”). Then, based on the front and rear wheel target pressures Ptf and Ptr, the front wheel pressure Pwf and the rear wheel pressure Pwr are adjusted to be different from each other. Therefore, in the first state, the total front wheel braking force Fbf matches the sum of the front wheel regenerative braking force Fgf and the front wheel frictional braking force Fmf, and the total rear wheel braking force Fbr matches the rear wheel frictional braking force Fmr (that is, “Fbf=Fgf+Fmf, Fbr=Fmr”). In addition, since the ratio (actual value) of the total rear wheel braking force Fbr to the total front wheel braking force Fbf is controlled to match the required distribution Kq (target value), it is the prescribed value hb (that is, “Fbr/Fbf=Kq=Km=hb”).

When the state transitions from the first state to the second state (that is, when the energy regeneration by the regeneration device KCf becomes impossible), the front wheel target pressure Ptf and the rear wheel target pressure Ptr are determined to be equal. As a result, the front wheel pressure Pwf and the rear wheel pressure Pwr are adjusted to match each other. Specifically, the energization of the second pressure adjusting valve UB is stopped, and the second pressure adjusting valve UB is fully opened. As a result, the first servo pressure Pa (=Pm=Pwf) and the second servo pressure Pb (=Pwr) are forcibly equalized, and “Pwf=Pwr” is achieved.

In the vehicle JV, the specifications of the front wheel and rear wheel braking devices SXf and SXr are set to satisfy “Km=hb”. Therefore, when the regeneration device KCf is in a malfunction state (for example, a failure state) and the regenerative braking force Fgf is not generated, the ratio of the rear wheel braking force Fmr (that is, the rear wheel frictional braking force Fmr) to the total front wheel braking force Fbf (that is, the front wheel frictional braking force Fmf) is maintained at the set distribution Km (that is, the prescribed value hb) by setting “Pwf=Pwr”. Therefore, since the ratio does not change even in the second state, the directional stability of the vehicle JV is maintained. In addition, a sufficient braking force can be ensured.

Furthermore, in the braking control device SC, the front wheel target pressure Ptf is smoothly increased due to the malfunction of the regeneration device KCf, not suddenly. Specifically, the temporal change amount (increase gradient) dPf of the front wheel target pressure Ptf is limited to a prescribed gradient kf (preset constant). Then, the first current Ia is gradually increased based on the front wheel target pressure Ptf. At the same time, the second current Ib is gradually decreased based on the difference sPt (target pressure difference) between the front wheel target pressure Ptf and the rear wheel target pressure Ptr. When the state transitions from the first state to the second state, “Pwf=Pwr” is smoothly achieved, so that a sudden change in the vehicle body acceleration Gx is suppressed, and deterioration in riding comfort is avoided. In addition, vehicle behavior disturbance may also be avoided.

### <Operation in Regeneration Cooperative Control of Braking Control Device SC According to First Embodiment>

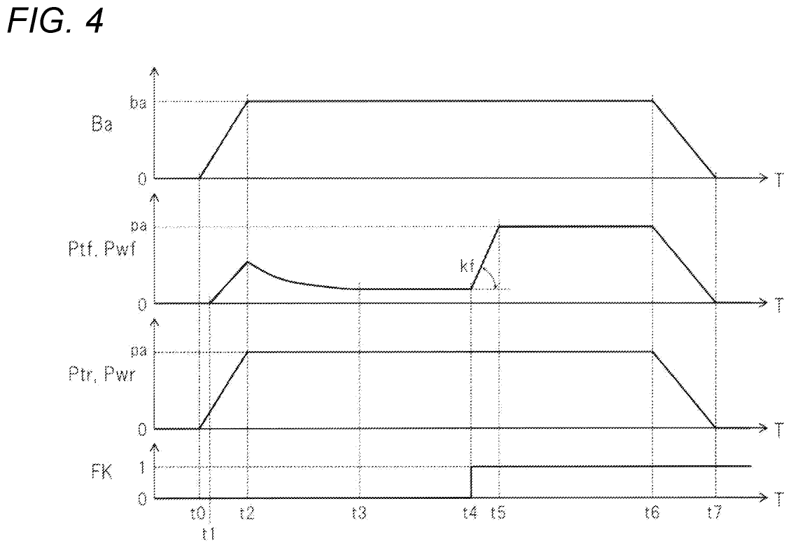

The operation (in particular, calculation of front and rear wheel target pressures Ptf and Ptr) of the regeneration cooperative control of the braking control device SC according to the first embodiment will be described with reference to a time-series diagram of FIG. 4 (diagram representing transition of various state quantities with respect to time T). In the regeneration cooperative control, since the actual values Pwf and Pwr are controlled to match the target values Ptf and Ptr, the diagram of the target pressure Pt and the diagram of the wheel pressure Pw overlap with each other.

In the examples, the following is assumed.

The regeneration device KCf is provided only on the front wheel WHf. Therefore, the regenerative braking force Fgf and the frictional braking force Fmr act on the front wheel WHf, and only the frictional braking force Fmr acts on the rear wheel WHr.

In the braking control device SC, the pressure receiving area ru of the servo chamber Ru is equal to the pressure receiving area rm of the master chamber Rm. Therefore, the master pressure Pm is equal to the first servo pressure Pa.

The front wheel pressure Pwf (=Pm) is adjusted by the first servo pressure Pa. The first servo pressure Pa is feedback-controlled such that the master pressure Pm (detection value of the master pressure sensor PM) matches the front wheel target pressure Ptf.

At time point t0, the operation of the braking operation member BP is started. Accordingly, the front and rear wheel required braking forces Fqf and Fqr are increased from time point t0 according to the increase in the braking operation amount Ba. From time point t0, the rear wheel target frictional braking force Fnr is increased, and the rear wheel target pressure Ptr is increased. Since the front wheel required braking force Fqf is in a state of the limit regenerative braking force Fxf or less from time point t0 to time point t1, the front wheel target frictional braking force Fnf remains “0”. Therefore, the front wheel target pressure Ptf is determined to be “0”.

At time point t1, “Fqf=Fxf” is obtained. After time point t1, the front wheel target frictional braking force Fnf is increased and the front wheel target pressure Ptf is increased in accordance with the increase in the braking operation amount Ba. At time point t2, the braking operation member BP is held. After time point t2, since the generator rotational speed Ngf decreases as the vehicle body speed Vx decreases, the limit regenerative braking force Fxf is increased (see the calculation map Zfx in FIG. 3). Therefore, since the front wheel regenerative braking force Fgf increases, the front wheel target pressure Ptf is reduced.

At time point t3, the rotational speed Ngf of the front wheel generator GNf decreases to the first prescribed speed vo, and the limit regenerative braking force Fxf reaches the upper limit value fxf. Since the state of “Fxf=fxf (prescribed upper limit value)” is maintained after time point t3, the front wheel target pressure Ptf is calculated to be constant.

At time point t4, the regeneration device KCf enters a malfunction state (for example, a failure state), and the regenerative braking force Fgf cannot be generated. At time point t4, the operation flag FK transmitted from the regenerative controller ECf to the controller ECU is switched from “0 (first state)” to “1 (second state)”. At time point t4, the increase in the front wheel pressure Pwf is started based on the operation flag FK. Specifically, the front wheel target pressure Ptf is increased after being limited by a prescribed gradient kf (preset constant). As a result, the current value Ia (first current) to the first pressure adjusting valve UA is gradually increased, and the current value Ib (second current) to the second pressure adjusting valve UB is gradually decreased.

At time point t5, the second current Ib is set to “0”, and the second pressure adjusting valve UB is fully opened. As a result, the first servo pressure Pa and the second servo pressure Pb become equal, and the front wheel pressure Pwf and the rear wheel pressure Pwr are made equal. Since “Ib=0” is continued after time point t5, the state of “Pwf=Pwr” is maintained. At time point t6, the held braking operation member BP is returned. Accordingly, the front and rear wheel pressures Pwf and Pwr are decreased toward “0”.

### Second Embodiment of Braking Control Device SC

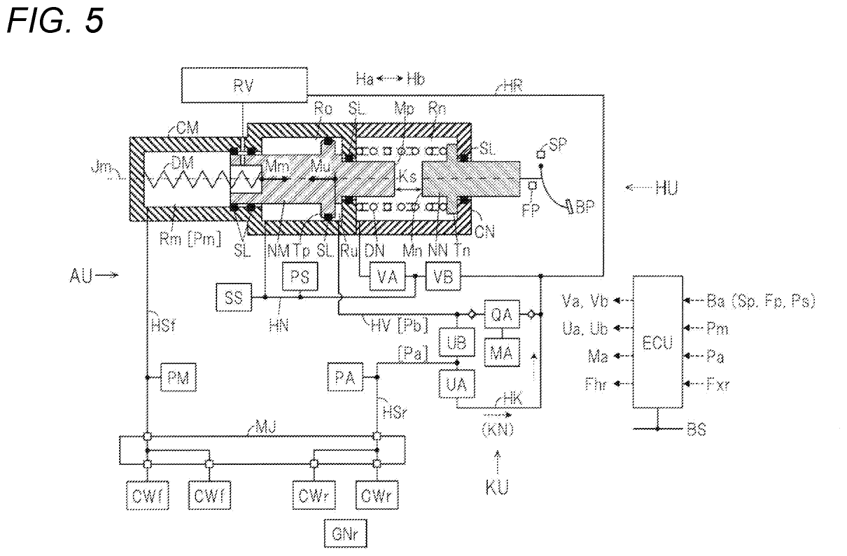

A second embodiment of the braking control device SC will be described with reference to the schematic view of FIG. 5. In the vehicle JV equipped with the braking control device SC according to the first embodiment, the regeneration device KCf is provided on the front wheel WHf. Conversely, in the vehicle JV on which the braking control device SC according to the second embodiment is mounted, a regeneration device KCr is provided on the rear wheel WHr as indicated by a broken line and a symbol with square brackets in the schematic view of FIG. 1. The regeneration device KCr (also referred to as “rear wheel regeneration device KCr”) includes a generator GNr (also referred to as “rear wheel generator”), a controller EGr for the generator GNr, and a storage battery BT for the regeneration device KCr.

In the vehicle JV on which the braking control device SC according to the second embodiment is mounted, the regenerative braking force is not generated on the front wheel WHf, and a regenerative braking force Fgr is generated only on the rear wheel WHr. Therefore, in the second embodiment of the braking control device SC, the first servo pressure Pa is supplied to the rear wheel cylinder CWr, and the second servo pressure Pb is supplied to the servo chamber Ru. Hereinafter, differences between the first embodiment and the second embodiment will be described. Note that the first embodiment and the second embodiment are the same except for the differences.

In the braking control device SC according to the second embodiment, in the braking system related to the front wheel WHf, the reflux passage HK is connected to the servo chamber Ru through the servo passage HV between the discharge unit of the fluid pump QA and the second pressure adjusting valve UB. Therefore, the second servo pressure Pb is supplied to the servo chamber Ru. The second servo pressure Pb generates the master pressure Pm via the master piston NM. Since the master pressure Pm is supplied to the front wheel cylinder CWf, the front wheel pressure Pwf is finally generated by the second servo pressure Pb.

In the braking system related to the rear wheel WHr, the reflux passage HK is connected to the rear wheel cylinder CWr between the first pressure adjusting valve UA and the second pressure adjusting valve UB via the rear wheel communication path HSr and the fluid pressure modulator MJ. Therefore, the first servo pressure Pa is directly supplied to the rear wheel cylinder CWr. Therefore, the rear wheel pressure Pwr is generated by the first servo pressure Pa. The pressurizing unit KU is provided with a servo pressure sensor PA (also referred to as “first servo pressure sensor”) so as to detect the first servo pressure Pa.

In the second embodiment, in the first state, the front wheel target pressure Ptf and the rear wheel target pressure Ptr are individually calculated based on the rear wheel regenerative braking force Fgr such that the required distribution Kq (that is, “Fqr/Fqf”) matches the prescribed value hb (that is, the set distribution Km). Then, based on the front and rear wheel target pressures Ptf and Ptr, the front wheel pressure Pwf and the rear wheel pressure Pwr are adjusted to be different from each other. That is, in the first state, the total front wheel braking force Fbf matches the front wheel frictional braking force Fmf, and the total rear wheel braking force Fbr matches the sum of the rear wheel regenerative braking force Fgf and the rear wheel frictional braking force Fmr (that is, “Fbf=Fmf, Fbr=Fgr+Fmr”). The ratio (actual value) of the total rear wheel braking force Fbr to the total front wheel braking force Fbf is controlled to match the required distribution Kq (target value) similarly to the first embodiment, and thus is the prescribed value hb (that is, “Fbr/Fbf=Kq=Km=hb”).

Next, regeneration cooperative control according to the second embodiment will be described with reference to a flowchart of FIG. 3. The regeneration cooperative control in the second embodiment corresponds to the description in which “front wheel” is replaced with “rear wheel”, the suffix “f” at the end of the symbol is replaced with “r”, and the suffix “r” is replaced with “f” in the processing of steps S140 and S150.

In step S140, a limit regenerative braking force Fxr of the rear wheel WHr is calculated and acquired based on the calculation map similar to the calculation map Zfx and a rotational speed Ngr (alternatively, the vehicle body speed Vx) of the rear wheel generator GNr. Then, in step S150, the limit determination of “the rear wheel required braking force Fqr is larger than the limit regenerative braking force Fxr or not” is executed. When the rear wheel required braking force Fqr is equal to or less than the limit regenerative braking force Fxr, a target regenerative braking force Fhr is calculated equal to the rear wheel required braking force Fqr, the front wheel target frictional braking force Fnf is calculated equal to the front wheel required braking force Fqf, and the rear wheel target frictional braking force Fnr is calculated to “0”. That is, when “Fqr≤Fxr”, “Fhr=Fqr, Fnf=Fqf, Fnr=0” is determined.

On the other hand, when the rear wheel required braking force Fqr is larger than the limit regenerative braking force Fxr, the target regenerative braking force Fhr is calculated as the limit regenerative braking force Fxr, the front wheel target frictional braking force Fnf is calculated equal to the front wheel required braking force Fqf, and the rear wheel target frictional braking force Fnr is calculated to a value obtained by subtracting the limit regenerative braking force Fxr from the rear wheel required braking force Fqr. That is, in the case of “Fqr>Fxr”, “Fhr=Frf, Fnf=Fqf, Fnr=Fqr−Fxr” is determined. The target regenerative braking force Fhr is transmitted from the brake controller ECU to the rear wheel regenerative controller EGr through the communication bus BS. The regenerative controller EGr controls the rear wheel generator GNr such that the actual rear wheel regenerative braking force Fgr approaches and matches the target regenerative braking force Fhr.

### Operation in Regeneration Cooperative Control of Braking Control Device SC According to Second Embodiment

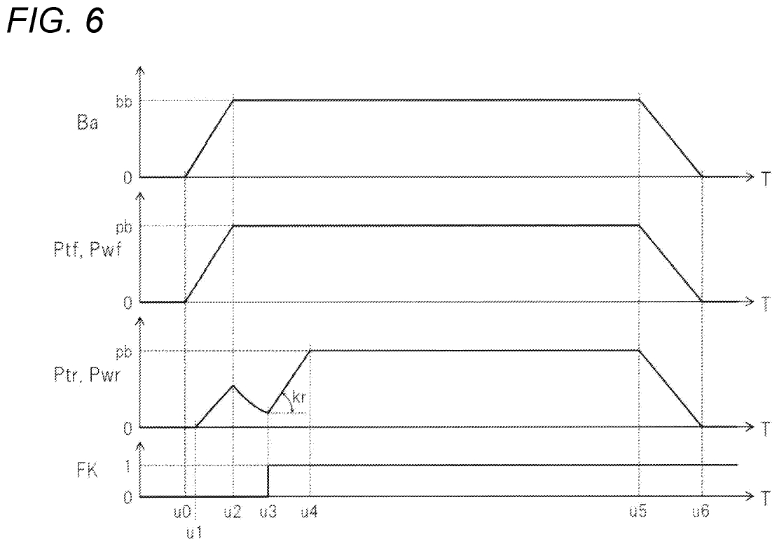

The operation (in particular, the calculation of the front and rear wheel target pressures Ptf and Ptr) of the braking control device SC according to the second embodiment in the regeneration cooperative control will be described with reference to a time-series diagram of FIG. 6 (transition diagram of various state quantities with respect to time T). In the regeneration cooperative control, since the actual values Pwf and Pwr are controlled to match the target values Ptf and Ptr, the diagram of the target pressure Pt and the diagram of the wheel pressure Pw overlap with each other.

In the examples, the following is assumed. The regeneration device KCr is provided only on the rear wheel WHr. Therefore, only the frictional braking force Fmf acts on the front wheel WHf, and the regenerative braking force Fgr and the frictional braking force Fmr act on the rear wheel WHr.

In the braking control device SC, the pressure receiving area ru of the servo chamber Ru is equal to the pressure receiving area rm of the master chamber Rm. Therefore, “Pb=Pm”.

The front wheel pressure Pwf (=Pm) is adjusted by the second servo pressure Pb. The second servo pressure Pb is feedback-controlled such that the master pressure Pm (detection value of the master pressure sensor PM) matches the front wheel target pressure Ptf.

At time point u0, the operation of the braking operation member BP is started. Accordingly, the front and rear wheel required braking forces Fqf and Fqr are increased from time point u0 according to the increase in the braking operation amount Ba. From time point t0, the front wheel target frictional braking force Fnf is increased, and the front wheel target pressure Ptf is increased. Since the rear wheel required braking force Fqr is in a state of the limit regenerative braking force Fxr or less from time point u0 to time point u1, the rear wheel target frictional braking force Fnr remains “0”. Since the state of “Fqr>Fxr” is obtained after time point u1, the rear wheel target frictional braking force Fnr is increased and the rear wheel target pressure Ptr is increased according to the increase in the braking operation amount Ba.

At time point u3, the regeneration device KCr enters a malfunction state (for example, a failure state), and the rear wheel regenerative braking force Fgr cannot be generated. At time point u3, the operation flag FK is switched from “0 (first state)” to “1 (second state)”. At time point u3, the increase in the rear wheel pressure Pwr is started based on the transition of the operation flag FK. Specifically, the rear wheel target pressure Ptr is limited by a prescribed gradient kr (preset constant) and then increased to match the front wheel target pressure Ptf. As a result, the supply current Ia (first current) to the first pressure adjusting valve UA is gradually increased, and the supply current Ib (second current) to the second pressure adjusting valve UB is gradually decreased. In the second embodiment, the first current Ia is gradually increased based on the rear wheel target pressure Ptr. At the same time, the second current Ib is gradually decreased based on the target pressure difference sPt (=Ptf−Ptr) between the front wheel target pressure Ptf and the rear wheel target pressure Ptr.

At time point u4, the power supply (energization) to the second pressure adjusting valve UB is completely stopped, and the second pressure adjusting valve UB is fully opened. As a result, the first servo pressure Pa and the second servo pressure Pb become equal, and the front wheel pressure Pwf and the rear wheel pressure Pwr coincide with each other. Since “Ib=0” is continued after time point u4, the state of “Pwf=Pwr” is maintained. At time point u5, the held braking operation member BP is returned. Accordingly, the front and rear wheel pressures Pwf and Pwr are decreased toward “0”.

### SUMMARY OF EMBODIMENTS

Hereinafter, embodiments of the braking control device SC will be summarized. The vehicle JV to which the braking control device SC is applied includes a regeneration device KC (KCf or KCr) on one of the front wheel WHf and the rear wheel WHr. The vehicle JV is configured such that the ratio Km of the rear wheel frictional braking force Fmr to the front wheel frictional braking force Fmf becomes a prescribed value hb in a state where the front and rear wheel pressures Pwf and Pwr are equal (that is, the state of “Pwf=Pwr”).

The braking control device SC includes an actuator HU and a controller ECU. The actuator HU (fluid unit) adjusts the fluid pressure Pwf (front wheel pressure) of the front wheel cylinder CWf. Then, the front wheel frictional braking force Fmf is generated by the front wheel pressure Pwf. In addition, the actuator HU adjusts the fluid pressure Pwr (rear wheel pressure) of the rear wheel cylinder CWr. The rear wheel frictional braking force Fmr is generated by the rear wheel pressure Pwr. The controller ECU controls the actuator HU. That is, the front and rear wheel pressures Pwf and Pwr are adjusted by the controller ECU through the actuator HU.

When the operation of the regeneration device KC is appropriate and the kinetic energy of the vehicle JV can be regenerated and the regenerative braking force Fg can be generated by the regeneration device KC (that is, in the case of the first state), the controller ECU individually adjusts the regenerative braking force Fg and the front and rear wheel pressures Pwf and Pwr so that the ratio of the total braking force Fbr of the rear wheel WHr (the total sum of the braking forces acting on the rear wheel WHr) to the total braking force Fbf of the front wheel WHf (the total sum of the braking forces acting on the front wheel WHf) becomes a prescribed value hb. On the other hand, when the operation of the regeneration device KC malfunctions, the kinetic energy of the vehicle JV cannot be regenerated by the regeneration device KC, and the regenerative braking force Fg cannot be generated (that is, in the case of the second state), the controller ECU adjusts the front wheel pressure Pwf to be equal to the rear wheel pressure Pwr.

In the braking control device SC, regeneration cooperative control (control in which the regenerative braking force Fg and the frictional braking force Fm cooperate) is executed. In the regeneration cooperative control, the target regenerative braking forces Fhf and Fhr (as a result, the regenerative braking forces Fgf and Fgr) and the target pressures Ptf and Ptr (as a result, the wheel pressures Pwf and Pwr) are determined so that the ratio Kq (required distribution) of the rear wheel required braking force Fqr to the front wheel required braking force Fqf is maintained at a prescribed value hb (preset constant). In the vehicle JV, when the front wheel pressure Pwf and the rear wheel pressure Pwr are the same, the specifications of the braking device SX are set such that the ratio Km (set distribution) of the rear wheel frictional braking force Fmr (braking force by the rear wheel pressure Pwr) to the front wheel frictional braking force Fmf (braking force by the front wheel pressure Pwf) becomes a prescribed value hb (that is, “Km=Fmr/Fmf=hb”). Therefore, even when the state transitions from the first state to the second state, the ratio of the total rear wheel braking force Fbr to the total front wheel braking force Fbf is maintained constant at the prescribed value hb by adjusting the front wheel pressure Pwf and the rear wheel pressure Pwr to match each other. Therefore, even when the regeneration device KC cannot perform energy regeneration, vehicle stability can be secured.

Furthermore, in the braking control device SC, when the front and rear wheel pressures Pwf and Pwr are matched, the increase gradient of the fluid pressure on the increased side is limited. Specifically, in the vehicle JV in which the regeneration device KCf is provided on the front wheel WHf, the temporal change amount (increase gradient) dPf of the front wheel target pressure Ptf is limited to a prescribed gradient kf (preset constant), and the front wheel target pressure Ptf (as a result, the front wheel pressure Pwf) is increased. Conversely, in the vehicle JV in which the regeneration device KCr is provided on the rear wheel WHr, the temporal change amount (increase gradient) dPr of the rear wheel target pressure Ptr is limited to the prescribed gradient kr (preset constant), and the rear wheel target pressure Ptr (as a result, the rear wheel pressure Pwr) is increased. Since the temporal change amount dP is limited in the increase of the target pressure Pt, the front and rear wheel pressures Pwf and Pwr are smoothly matched. Therefore, a sudden change in the vehicle body acceleration Gx is suppressed, and as a result, a decrease in the ride comfort of the vehicle JV can be avoided.

For example, the actuator HU includes a “fluid pump QA driven by the electric motor MA” and a “first and second pressure adjusting valves UA and UB provided in a reflux passage HK connecting a suction portion and a discharge unit of the fluid pump QA”. Then, the first and second servo pressures Pa and Pb are adjusted by the first and second pressure adjusting valves UA and UB. Specifically, the first servo pressure Pa is adjusted only by the first pressure adjusting valve UA, and the second servo pressure Pb is adjusted by both the first and second pressure adjusting valves UA and UB.

In the vehicle JV in which the regeneration device KCf (in particular, the generator GNf) is provided on the front wheel WHf, the first servo pressure Pa is transmitted to the front wheel cylinder CWf via the master piston NM, whereby the front wheel pressure Pwf is adjusted, and the second servo pressure Pb is directly supplied to the rear wheel cylinder CWr, whereby the rear wheel pressure Pwr is adjusted. That is, since “Pwf≤ Pwr” is satisfied in the vehicle JV in which the regeneration device KCf is provided on the front wheel WHf, the front wheel pressure Pwf is adjusted to be lower than the rear wheel pressure Pwr when the operation of the regeneration device KCf is appropriate (that is, in the case of the first state).

On the other hand, in the vehicle JV in which the regeneration device KCr (in particular, the generator GNr) is provided on the rear wheel WHr, the second servo pressure Pb is transmitted to the front wheel cylinder CWf via the master piston NM, whereby the front wheel pressure Pwf is adjusted, and the first servo pressure Pa is directly supplied to the rear wheel cylinder CWr, whereby the rear wheel pressure Pwr is adjusted. That is, since “Pwf≥Pwr” in the vehicle JV in which the regeneration device KCr is provided on the rear wheel WHr, the rear wheel pressure Pwr is adjusted to be lower than the front wheel pressure Pwf when the operation of the regeneration device KCr is appropriate (that is, in the case of the first state).

In the above configuration, “Pwf=Pwr” at the time of malfunction of the regeneration device KC is achieved by stopping the energization to the second pressure adjusting valve UB. When the energization of the second pressure adjusting valve UB is stopped, the current value Ib is gradually decreased and finally set to “0”. As a result, since the fluid pressure is smoothly increased in the transition from the first state to the second state, a sudden change in the vehicle body acceleration Gx is avoided, and good ride comfort is secured.

1. A braking control device for a vehicle which is applied to a vehicle which includes a regeneration device on one of a front wheel and a rear wheel, the braking control device comprising:
an actuator that generates a front wheel frictional braking force by adjusting a front wheel pressure of a front wheel cylinder provided on the front wheel, and generates a rear wheel frictional braking force by adjusting a rear wheel pressure of a rear wheel cylinder provided on the rear wheel; and
a controller that controls the actuator, wherein
the vehicle is configured such that a ratio of the rear wheel frictional braking force to the front wheel frictional braking force becomes a prescribed value in a state where the front and rear wheel pressures are equal, and
the controller is configured to:
individually adjust the front and rear wheel pressures based on a regenerative braking force such that a ratio of a total braking force of the rear wheel to a total braking force of the front wheel becomes the prescribed value in a first state in which the regeneration device can generate the regenerative braking force, and
adjust the front wheel pressure and the rear wheel pressure to be equal in a second state in which the regeneration device cannot generate the regenerative braking force.

2. The braking control device for a vehicle according to claim 1, wherein
the regeneration device is provided on the front wheel, and
the controller adjusts the front wheel pressure to be lower than the rear wheel pressure in the first state.

3. The braking control device for a vehicle according to claim 1, wherein
the regeneration device is provided on the rear wheel, and
the controller adjusts the front wheel pressure to be higher than the rear wheel pressure in the first state.
